(19) United States
(12) Patent Application Publication
(10) Pub. No.: US 2013/0282405 A1
(43) Pub. Date: Oct. 24, 2013

(54) METHOD FOR STEPWISE REVIEW OF PATIENT CARE

(71) Applicants: Cornelis Conradus Adrianus Van Zon, Fishkill, NY (US); William Palmer Lord, Fishkill, NY (US); Charles Lagor, Ardsley, NY (US)

(72) Inventors: Cornelis Conradus Adrianus Van Zon, Fishkill, NY (US); William Palmer Lord, Fishkill, NY (US); Charles Lagor, Ardsley, NY (US)

(73) Assignee: KONINKLIJKE PHILIPS N.V., Eindhoven (NL)

(21) Appl. No.: 13/996,586

(22) PCT Filed: Dec. 9, 2011
(86) PCT No.: PCT/IB2011/055562

§ 371 Date: Jun. 21, 2013

Related U.S. Application Data
(60) Provisional application No. 61/425,398, filed on Dec. 21, 2010.

(51) Int. Cl. G06F 19/00; G06Q 50/24

(52) U.S. Cl. CPC G06F 19/3443; G06Q 50/24
USPC 705/3

(57) ABSTRACT

A method and apparatus for managing clinical protocols and/or computer interpretable guidelines includes receiving workflow data and patient data for a plurality of patients. The workflow data includes a sequence of care steps performed on each of the patients. The patient data includes clinical data collected from each patient. The patient data as of the time each of the plurality of care steps was performed on each of the patients is tracked. Once of the previous care steps for one of the patients is selected which cause at least a portion of the sequence of care steps and the patient data as of the time of the selected care step for the selected patient to be displayed.

The present application relates generally to clinical decision making. It finds particular application in conjunction with tracking and/or reviewing the performance of the workflow or steps of clinical workflow management and/or decision support (CWM/DS) systems, and will be described with particular reference thereto. However, it is to be understood that it also finds application in other usage scenarios, and is not necessarily limited to the aforementioned application.

Clinical protocols (also referred to as care protocols) are the procedures established by medical institutions, such as hospitals, to follow when caring for patients. These protocols aim at ensuring the health and safety of patients while minimizing the cost of care. Typically, clinical protocols are derived from clinical guidelines. Clinical guidelines are recommendations on the appropriate treatment and care for people with specific diseases and conditions based on the best available evidence.

A CWM/DS system is a system that provides one or more of administrators, clinicians, patients, and the like with clinical recommendations that are intelligently filtered and presented at appropriate times. To accomplish this, the CWM/DS system executes the computer interpretable guidelines (CIGs) on a per patient basis. A CIG is typically comprised of a plurality of care steps and incorporates recommendations as to how to treat and/or care for a patient based on the present care step. Further, a CIG typically embodies a clinical protocol of the medical institution employing the CIG. Therefore, CIGs embodying clinical protocols derived from clinical guidelines support medical institutions in adhering to the clinical guidelines.

One challenge with employing CWM/DS systems is that medical care can range from acute care (e.g. heart attack, stroke, and the like) to long-term care (diabetes, cancer, and the like). Anywhere along this spectrum, patient care can involve many discrete steps, taken in a short amount of time in rapid succession or spread out over longer periods of time. Moreover, these discrete steps can involve a variety of different healthcare providers. As a result, obtaining a comprehensive overview of a patient case with many care steps can be difficult.

The present application provides new and improved systems and methods for the management of CWM/DS systems which overcomes the above-referenced problems and others.

In accordance with one aspect, a method of managing clinical protocols and/or computer interpretable guidelines is provided. The method comprising receiving workflow data and patient data for a plurality of patients, the workflow data includes a plurality of care steps for each of the patients and the patient data includes clinical data collected from each of the patient (suitably including patient symptoms (e.g., chief complaints), patient findings (e.g., physical exam findings), laboratory data (e.g., creatinine values), physiological data (e.g., blood pressure), workflow data, identification data (e.g., patient IDs), and the like), tracking the workflow and patient data for each of the plurality of care steps for each of the patients, selecting one of the previous care steps for one of the patients, and causing the workflow data and the patient data at the time of the selected previous care step for the selected patient to be displayed.

In accordance with another aspect, a system for managing clinical protocols and/or clinical guidelines is provided. A data collection engine receives workflow data and patient data for a plurality of patients, the workflow data includes a plurality of care steps for each of the patients and the patient data includes clinical data collected from each of the patient. A data analysis engine tracks the workflow and patient data for each of the patients and causes the workflow data and the patient data at the time of a selected previous care step for a select one of the patients to be displayed on a display.

In accordance with another aspect, a clinical workflow or decisions support manager is provided. A data collection engine collects workflow data and patient for at least one patient, the workflow data including a plurality of care steps for a clinical protocol and/or computer interpretable guideline describing the patient's diagnosis and treatment regimen and the patient data including clinical data collected from the patient over time. A data analysis engine tracks the patient data as of the time at which each of the care steps for the patient is performed. A display displays the steps of workflow and patient data at the time a selected one of the care steps was performed on the patient.

One advantage of the present systems and methods resides in the ability to track steps that have been performed within a workflow of a CWM/DS system.

Another advantage resides in the ability to identify potential inefficiencies in the clinical protocols and/or clinical guidelines of a CWM/DS system.

Another advantage resides in the ability to review the care process in a patient case.

Another advantage resides in the ability to conduct a predictive analysis in a patient case.

Another advantage resides in increased patient throughput.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

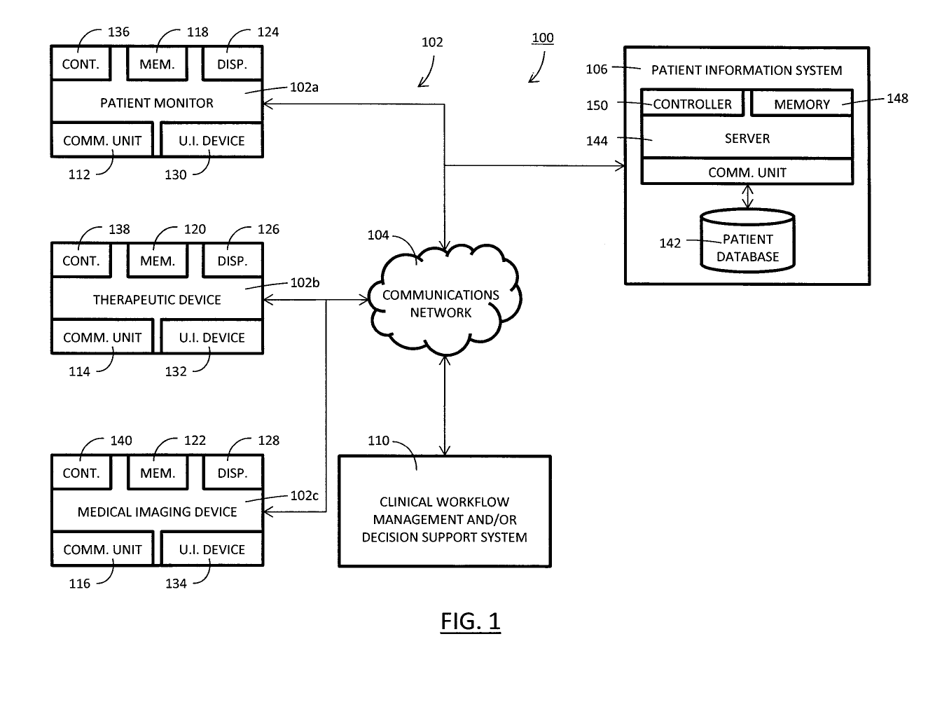

FIG. 1 is a block diagram an information technology (IT) infrastructure of a medical institution according to aspects of the present disclosure;

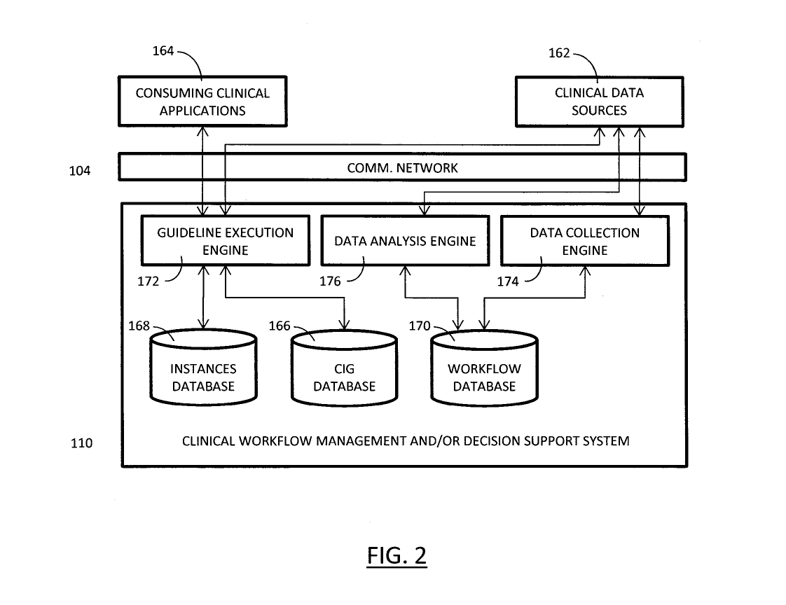

FIG. 2 is a block diagram of functional components of a clinical workflow management and/or decision support (CWM/DS) system according to aspect of the present disclosure;

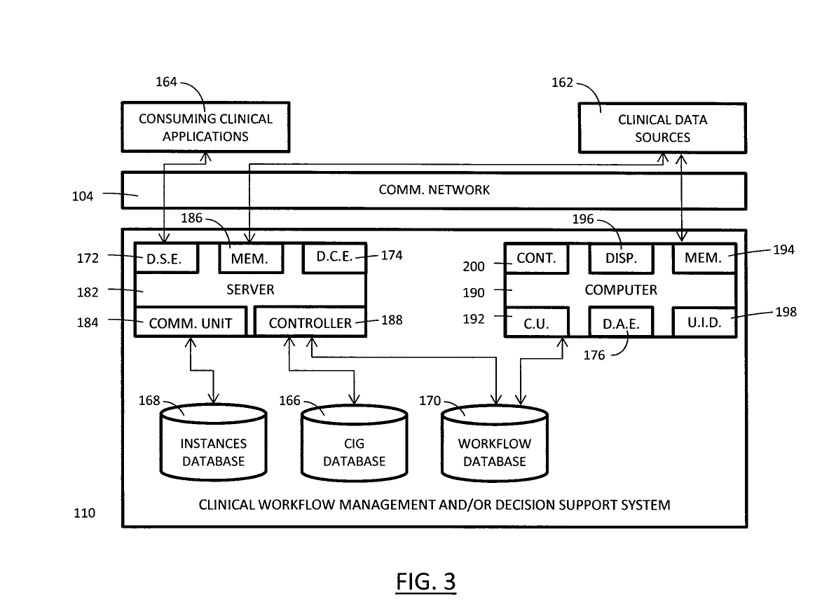

FIG. 3 is a block diagram of structural components of a CWM/DS system according to aspect of the present disclosure;

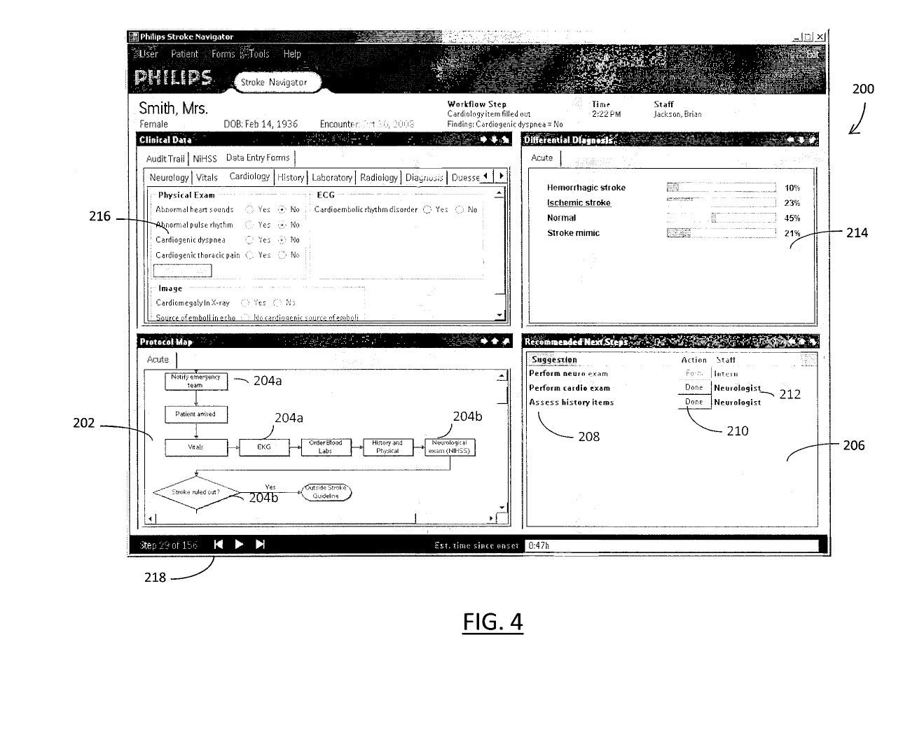

FIG. 4 illustrates a user interface of a CWM/DS system according to aspect of the present disclosure; and

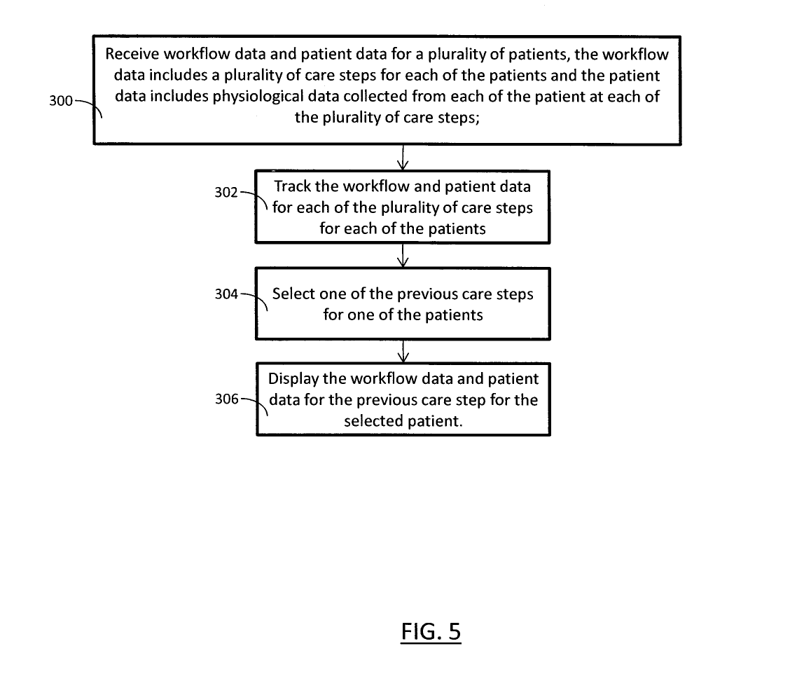

FIG. 5 illustrates the core operation of a CWM/DS system according to aspect of the present disclosure.

With reference to FIG. 1, a block diagram an information technology (IT) infrastructure 100 of a medical institution, such as a hospital, is provided. The IT infrastructure 100 typically includes one or more clinical devices 102, a communications network 104, a patient information system 106, a clinical workflow management and/or decision support (CWM/DS) system 110, and the like. However, it is to be understood that more or less components and/or different arrangements of components are contemplated.

The clinical device(s) 102 include one or more of patient monitors, devices at patient beds, mobile communications devices carried by clinicians, clinician workstations, settings of treatment providing equipment, and the like at various physical locations in the medical institution. Further, each of the clinical device(s) 102 is associated with one or more patients and/or one or more clinicians. For example, a patient monitor attached to a patient and/or a clinician's workstation configured to receive clinical knowledge for a plurality of patients. Each of the patient(s) associated with the clinical device(s) 102 is associated with one or more clinical problems, such as diseases or medical conditions.

As illustrated, the clinical device(s) 102 include a patient monitor 102a, a therapeutic device 102b, and a medical imaging device 102c. Others, of course, are contemplated. Communications units 112, 114, 116 of the clinical device(s) 102 facilitate communication with external systems and/or databases, such as the CWM/DS system 110, via the communications network 104. Memories 118, 120, 122 of the clinical device(s) 102 store executable instructions for performing one of more of the functions associated with the clinical device(s) 102. Displays 124, 126, 128 of the clinical device(s) 102 allow the clinical device(s) 102 to display data and/or messages for the benefit of corresponding users. User input devices 130, 132, 134 of the clinical device(s) 102 allow the corresponding users of the clinical device(s) 102 to interact with the clinical device(s) 102 and/or respond to messages displayed on the displays 124, 126, 128. Controllers 136, 138, 140 of the clinical device(s) 102 execute instructions stored on the memories 118, 120, 122 to carry out the functions associated with the clinical device(s) 102.

The communications network 104 allows communication between components of the medical institution connected thereto, such as the CWM/DS system 110 and the clinical device(s) 102, and is suitable for the transfer of digital data between the components. Suitably, the communications network 104 is a local area network. However, it is contemplated that the communications network 104 is one or more of the Internet, a wide area network, a wireless network, a wired network, a cellular network, a data bus, such as USB and I2C, and the like.

The patient information system 106 acts as a central repository of electronic medical records (EMRs) for patients. Patient data from the clinical device(s) 102 and other devices generating patient data are suitably stored in the patient information system 106. In some instances, patient data are received directly from the source of the patient data, and, in other instances, patient data are received indirectly from the source of the patient data. For example, patient data generated by one of the clinical device(s) 102 are received indirectly from the CWM/DS system 110.

Typically, the patient information system 106 includes one of more of a database 142, a server 144, and the like. The database 142 stores EMRs for patients of the medical institution. The server 144 allows components of the medical institution to access to the EMRs via the communications network 104. A communications unit of the server 144 facilitates communication between the server 144 and external devices, such as the clinical device(s) 102, via the communications network 104. The communications unit 146 further facilitates communication with the database 142 of the patient information system 106. A memory 148 of the server 144 stores executable instructions for performing one of more of the functions associated with the server 144. A controller 150 of the server 144 executes instructions stored on the memory 148 to carry out the functions associated with the server 144.

The CWM/DS system 110 receives patient data from one or more clinical data sources 162 (see FIG. 2) and, in certain embodiments, provides clinical recommendations based on clinical protocols and/or clinical guidelines to one or more consuming clinical applications 164 (see FIG. 2) to promote adherence to the clinical protocols and/or clinical guidelines.

The clinical data sources 162 provide patient data for associated patients to the CWM/DS system 110. The patient data suitably includes clinical data, such as patient symptoms (e.g., chief complaints), patient findings (e.g., physical exam findings), laboratory data (e.g., creatinine values), physiological data (e.g., blood pressure), workflow data, identification data (e.g., patient IDs), and the like. It is contemplated that the workflow data identifies, for example, one or more of care steps performed, care steps currently being performed, care steps yet to be performed, and the like. Suitably, clinical data sources 162 continuously provide patient data to the CWM/DS system 110 as it becomes available. For example, if a patient monitor collects data from associated sensors every 5 seconds, newly collected patient data is provided every 5 seconds. However, it is contemplated that events other than the availability of patient data, such as timer events, workflow events, user input events, and the like result in the provisioning of patient data.

The consuming clinical applications 164 receive clinical recommendations for associated patients from the CWM/DS system 110. The clinical recommendations may include reminders, alerts, suggested next steps, background information, drug choices and dosages, and the like, that aim to assist clinicians with the treatment of the associated patients. To receive clinical recommendations for a patient, a consuming clinical application suitably registers with the CWM/DS system 110 to receive clinical recommendations for the patient.

The clinical data sources 162 suitably include at least one of: (1) one or more of the clinical devices 102; (2) the patient information system 106; (3) one or more of the auxiliary systems 108; (4) other devices and/or applications generating patient data; (5) the CWM/DS system 110, such as a user input device thereof; and (6) the like. The consuming clinical applications 164 suitably include at least one of: (1) one or more of the clinical devices 102; (2) the patient information system 106; (3) one or more of the auxiliary systems 108; (4) applications running on devices (e.g., PCs, cell-phones, etc.); (5) the CWM/DS system 110; and (6) the like. In certain embodiments, one or more of the components of the IT infrastructure 100 belong to both the clinical data sources 162 and the consuming clinical applications 164.

The CWM/DS system 110, as discussed in detail below, facilitates adherence to clinical protocols and/or clinical guidelines. Further, the CWM/DS 110 facilitates the tracking/managing and review of a patient case with the CWM/DS 110. In short, the instances or occurrences of all step events of a clinical protocol/guideline of a patient case, whether stemming from user input, clinical data sources 162, or other software applications, are stored in the CWM/DS system 110. For example, for each instance of a step event the CWN/DS system 110 logs and stores the workflow data including the type of step, the time the step occurred, the name or ID of the associated healthcare provider, links to any associated data, and the like. Further, the CWM/DS system 110 has provisions for accepting the aforementioned stored workflow data as actual events, allowing the workflow data to advance the CWM/DS system 110 to a new workflow or step as if the event actually occurred. The CWM/DS system 110 also enables users to review or replay the steps that occurred in the patient case in order to review the care process and/or the clinical protocols. To assure that the user interface shows the same state as when the associated patient data was first received, the system processes the stored data as actual data during the review process.

It is contemplated that the CWM/DS system 110 includes one or more devices, servers, computers, database, and the like implementing varying functional aspects of the CWM/DS system 110, described in detail hereafter. Further, although described as part of the CWM/DS system 110, it is contemplated that the tracking/managing and review of a patient case is performed by a component other than the CWM/DS system 110.

With reference to FIG. 2, a detailed view of the functional components of the CWM/DS system 110 according to aspects of the present disclosure is provided. The CWM/DS system 110 suitably includes a computer interpretable guideline (CIG) database 166, an instances database 168, a workflow database 170, a guideline execution engine 172, a data collection engine 174, a data analysis engine 176, and the like. It is to be appreciated these functional components are merely abstractions to simplify the discussion hereafter and are not intended to be construed as limiting the structural layout of the CWM/DS system 110.

The guideline execution engine 172 executes CIGs embodying clinical protocols of the medical institution. A clinical protocol typically includes one or more ideal care steps and timing or sequence for an occurrence of the care step(s) as a function of patient information and clinical problem. Further, a clinical protocol typically includes recommendations to perform specific care steps, with associated instructions. It is contemplated that the clinical protocols are derived from clinical guidelines, but other approaches to deriving the clinical protocols are contemplated. Suitably, the CIGs are stored within the CIG database 166 and indexed by clinical problem. However, it is contemplated that the CIGs are stored in other components of the medical institution.

To execute CIGs, the guideline execution engine 1728 creates instances of the CIGs stored in the CIG database 166 relevant to the clinical problems associated with the patients serviced by the medical institution. For example, when a patient with a particular clinical problem is admitted to the medical institution, the CWM/DS system 110 locates one or more ones of the CIGs in the CIG database 166 relevant to the patient and creates an instance for each one of more of these CIG for the patient. An instance of a CIG is a copy of a CIG tailored to a particular patient with patient data. The instances are suitably maintained in the instances database 168 and indexed by patient. However, it is contemplated that the instances are stored in other components of the medical institution.

The guideline execution engine 172 further maintains and/or updates the instances of the CIGs. As patient data relevant to one or more of the instances becomes available, the one or more instances are updated to reflect the updated patient information. For example, as a care step is performed for a particular patient, it is contemplated that one or more associated instances are updated to reflect that the care step has been performed. Relevant patient data includes one or more of clinical data, workflow data, and the like. It is contemplated that the patient data is received directly from components of the medical institution, such as the sourcing clinical device(s), or indirectly via a component of the medical institution, such as the patient information system 106.

While the guideline execution engine 172 is executing the CIGs, the guideline execution engine 172 provides clinical knowledge based on the instances of the CIGs to the consuming medical device(s) and/or other components of the medical institution. It is also contemplated that the CWM/DS system 110 itself may be the only consuming medical device and provides recommendations and instructions to the user through its display. As noted above, a CIG typically includes recommendations for care steps forming it. Hence, as an instance of a CIG is updated by, for example, completing a care step, recommendations and/or instructions from the new care step of the instance are provided to relevant one or more of the consuming medical device(s). In certain embodiments, the relevant consuming medical device(s) are the consuming medical device(s) that registered with the CWM/DS system 110 to receive clinical knowledge pertaining to a patient.

The data collection engine 174 collects workflow data pertaining to workflows actually employed by clinicians for managing a clinical problem, such as a disease or condition. This workflow data includes one or more of what care steps were performed, when they were performed, who performed them, what the result of performing them was, and the like. The workflow data is suitably stored in a workflow database 170. However, it is contemplated that the workflow data is stored in other components of the medical institution. In certain embodiments, the workflow data is collected from the sourcing clinical device(s) and/or other components of the medical institution, such as the patient information system 106. The workflow data is suitably collected electronically, but other approaches to collecting the workflow data are contemplated. For example, in certain embodiments, the workflow data is collected manually from, for example, a written form, and entered by a user into an electronic form for the CWM/DS system 110.

The data analysis engine 176 analyzes the workflow data in the workflow database 170 to facilitate the tracking/managing of step events of the clinical protocol for each patient case. The data analysis engine 176 tracks the patient data and workflow data for each step of the clinical protocol in real time. For example, the CWM/DS system 110 includes a live mode that enables to the user to track each step as it is performed on the patient. The data analysis engine 176 also analyzes the workflow data to determine if there is a deviation from the clinical protocol for a particular patient. For example, if a clinician deviates from the clinical protocol the CWM/DS system 110 will record the steps that were performed on the patient and insert them into the patient's workflow data and case.

Deviated step are preferably recorded electronically from the clinical device(s) 102, but other approaches for recording deviated steps are contemplated. The deviated steps can be recorded verbally or textually through an interface of the CWM/DS and are inserted as workflow data in the patient case. Deviations are recorded when a clinician does not follow the CIG as suggested. For example, if the CWM/DS system 110 suggests to perform steps A, B, and C and the clinician executes steps A, Z, and G, then the system determines a deviation has occurred.

The data analysis engine 176 also analyzes the workflow data to facilitate a review or replay of the steps events for each patient case. For example, the CWM/DS system 110 includes a review mode that enables the user to review or replay each step performed during a patient case. In review mode, a user can playback any selected patient case. The CWM/DS system 110 enables the user to review any of the past steps performed in a patient case. For example, the CWM/DS system 110 can allow the user to go to a first step, go back N steps where N can be set by the user, go to the previous step, go to the next step, go forward N steps, go to the last step, and the like. The CWM/DS system 110 can also allow the user to enter a specific step number and/or an indication of the current steps and total number of steps. When navigating to a selected step, the CWM/DS system 110 displays the same patient data that was present when the step was actually preformed. This allows rapid, stepwise review of the selected case. In review mode, the CWM/DS system 110 locks the workflow and patient data for each step so that it cannot be modified. It is also contemplated that the data analysis engine 172 and the guideline execution engine 172 are embodied as a single engine.

It is also contemplated the data analysis engine 176 analyzes the workflow data to facilitate a comparison of already executed steps for a patient case to an alternative hypothetical course of events, thereby allowing for a “what if” analysis. For example, the CWM/DS system 110 includes a comparative mode that enables the user to compare the actual course of clinical steps with a hypothetical course of clinical steps. This is the same as review mode, but with the option to switch to a pseudo-live mode at any point during the review. In comparative mode, the system behaves the same as in ‘live’ mode, the only difference being that care steps do not get stored in the database as part of the actual case. This enables user to vary the steps performed on the patient to view different possible outcomes of the patient case. The user is able to view the outcome of certain steps to further optimize the clinical protocol or to make the clinical process more efficient. For example, a user can deviate from the clinical protocol to determine if a performing a specific step out of order would conclude with the patient care being performed in a more efficient manner.

In another embodiment, the CWM/DS system 110 includes one or more decision support models such as a Bayesian network and the like. The patient data collected by the CWM/DS system drives the decision support models to provide one or more clinical recommendations. For example, a Bayesian network for stroke would use clinical data such as vital signs, past medical history, and the like to calculate the probability for stroke. In comparative mode, the CWM/DS system 110 utilizes the one or more decision support models in the same way as in the live mode. This enables the users to pursue a hypothetical path and observe whether or not the one or more decision support models yield a more accurate recommendation sooner.

In order to enable comparative analysis, the CWM/DS system 110 generates a probability model to calculate the conditional probability for each of a plurality of outcomes and diagnoses given the patient data at the time the step was performed. For example, if a user deviates from the clinical protocol and performs a step out of order, the CWM/DS system 110 will determine the probable outcome of that step based on the patient data available during that step. The patient information system 106 stores the patient record and patient data over the course of treatment of the current patient. The patient information system 106 also stores a plurality of historical patient records for different patients for the hospital, a care unit, regional and national care centers, and the like. The CWM/DS system 110 generates a model to simulate a patient with similar characteristics as the current patient. The plurality of historical patient records is searched for similar characteristics and patient data as the current patient. The CWM/DS system 110 inputs the outcomes and diagnoses of the historical cases that contain similar characteristics and patient data as the current patient into the model. The CWM/DS system 110 uses a probability model to calculate the conditional probability for each of the outcomes and diagnoses given the model. Probability models are constructed using mixture models that are efficiently learned by the Expectation-Maximization algorithm and the like. From the probability model, the CWM/DS system 110 determines the probability of a diagnosis or outcome of a certain care step given the patient data at the time the step was performed.

The CWM/DS system 100 also generates a user interface and/or a visualization of step events and/or workflow data performed during a patient case. It is also contemplated that the user interface and/or visualization can include the patient data for a particular patient at that step. For example, the visualization may be a display with boxes and arrows which show the particular step event provided in order. This permits a clinician to review the clinical protocol that was actually followed during clinical care. Moreover, when the physician clicks on one of the boxes or steps, the physician can view the time, the vital signs of the patient, and other medical information as it existed at that time. This enables the medical care professionals who provided the care, students, or the like, to review the care process. Reviewing the care process can be a valuable tool in improving the efficiency of the workflow and otherwise improving the care guidelines. The visualization can also include a probability of disease based on the patient data and the clinical protocol. It is contemplated that the user interface/visualization are displayed on the displays 124, 126, 128 of the clinical devices 102. The user interface/visualization can also be displayed on the display 192 of the CWM/DS system 110. It is also contemplated that the user interfaces 130, 132, 134 of the clinical devices 102 and the CWM/DS system 110 allow the user to view, manipulate, modify, and/or interact with the user interface/visualization.

With reference to FIGS. 3, a structural view of the CWM/DS system 110 is provided. A server 182 of the CWM/DS system 110 suitably includes the guideline execution engine 172 and the data collection engine 174. In certain embodiments, each of the guideline execution engine 172 and the data collection engine 174 is embodied by a non-transient computer readable medium having computer executable instructions for performing the tasks associated with the guideline execution engine 172 and/or the data collection engine 174. A communications unit 184 of the server 182 facilitates communication between the server 182 and external devices, such as the clinical device(s) 102. The communications unit 184 further facilitates communication with the databases 166, 168, 170 of the CWM/DS system 110. A memory 186 of the server 182 stores executable instructions for performing one of more of the functions associated with the server 182. In certain embodiments, these instructions include instructions for performing the tasks associated with the guideline execution engine 172 and/or the data collection engine 174. A controller 188 of the server 182 executes instructions of the memory 186, the guideline execution engine 172, or the data collection engine 174.

A computer 190 of the CWM/DS system 110 suitably includes the data analysis engine 176. In certain embodiments, the data analysis engine 176 is embodied by a non-transient computer readable medium having computer executable instructions for performing the tasks associated with the data analysis engine 176. A communications unit 192 of the computer 190 facilitates communication between the computer 190 and external devices, such as the clinical device(s) 102. The communications unit 192 further facilitates communication with the databases 166, 168, 170 of the CWM/DS system 110. A memory 194 of the computer 190 stores executable instructions for performing one of more of the functions associated with the computer 190. In certain embodiments, these instructions include instructions for performing the tasks associated with the data analysis engine 174. A display 196 of the computer 190 allows the computer 190 to display a user interface allowing a user, such as a knowledge engineer, to interact with data analysis engine 176. A user input device 198 of the computer 190 allows the user to interact with the user interface. A controller 200 of the computer 190 executes instructions of the memory 194 or the data analysis engine 176. It is also contemplated the server 182 and the server 190 are the embodied as a single device.

Each of the databases described herein, such as the CIG database 166, suitably include a computer database, where the computer database is embodied by a single computer, distributed across a plurality of computers, or the like. Further, each of the databases suitably stores data in a structured manner facilitating recall and access to such data. Further, as used herein, a memory includes one or more of a non-transient computer readable medium; a magnetic disk or other magnetic storage medium; an optical disk or other optical storage medium; a random access memory (RAM), read-only memory (ROM), or other electronic memory device or chip or set of operatively interconnected chips; an Internet server from which the stored instructions may be retrieved via the Internet or a local area network; or so forth. Further, as used herein, a controller includes one or more of a microprocessor, a microcontroller, a graphic processing unit (GPU), an application-specific integrated circuit (ASIC), a field-programmable gate array (FPGA), and the like; a communications network includes one or more of the Internet, a local area network, a wide area network, a wireless network, a wired network, a cellular network, a data bus, such as USB and I2C, and the like; a user input device includes one or more of a mouse, a keyboard, a touch screen display, one or more buttons, one or more switches, one or more toggles, and the like; and a display includes one or more of a LCD display, an LED display, a plasma display, a projection display, a touch screen display, and the like.

FIG. 4 illustrates a user interface 200 of the CWM/DS system. The user interface 200 includes the visualization 202 of the step events performed during a patient case. For example, the various nodes 204 each represent one step in the clinical process. The nodes 204 can vary in color to indicate the state of the step such as completed, in process, optional, skipped, deviated, not completed, and the like. The shapes of the node 204 indicate the various types of steps. The visualization 202 can also include the deviated steps as nodes 204a that were performed during the care process or are scheduled to be performed 204b. The user interface 200 also includes a recommended next step sector 206 that indicates the clinical protocol's next recommended steps. The recommended next step sector includes the suggested step 208, the status of the step 210, and the staff that performs the step 212. A differential diagnosis sector 214 determines the probability of various diseases for the patient. The differential diagnosis is based on the patient data. In order to determine the probable diagnosis, the CWM/DS system determines the probability of disease at each step of every clinical protocol with the current patient data. The user interface 200 includes a clinical data sector 216 that displays the patient history data. Step forward and review buttons 218 are also included in the user interface to allow the user to review prior or subsequent steps of the clinical protocol. The forward and review buttons 218 enable the user to go to a first step, go back N steps where N can be set by the user, go to the previous step, go to the next step, go forward N steps, go to the last step, and the like. This permits the user to review the protocol that was actually followed during clinical care. When reviewing a particular step, the user views the actual patient, workflow information, probable diagnosis that existed at that time. Moreover, when the physician clicks on one of the boxes or steps, the user views the associated patient and workflow data as it existed at that time.

FIG. 5 illustrates the core operation of the CWM/DS system. In a step 300, workflow data and patient data is received for a plurality of patients. The workflow data includes a plurality of care steps for each of the patients and the patient data includes clinical data collected from each of the patient at and times at which each care step was performed and which element of the patient data was collected. In a step 302, the workflow and patient data is tracked for each of the plurality of care steps for each of the patients. In a step 304, one of the previous care steps for one of the patients is selected. The workflow data and patient data at the time the previous care step was performed for the patient are displayed in a step 306.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method of tracking performed steps in clinical protocols and/or computer interpretable guidelines, the method comprising:
receiving workflow data and patient data for a plurality of patients, wherein the workflow data includes a plurality of care steps for each of the patients and the patient data includes clinical data collected from each of the patient;
tracking the workflow and patient data for each of the plurality of care steps for each of the patients;
selecting one of the previous care steps performed on one of the patients; and
causing the workflow data and the patient data at the time of the performance of the previous care step on the selected patient to be displayed.

2. The method according to claim 1, wherein each of the care steps are based on established clinical protocols and/or computer interpretable guidelines.

3. The method according to claim 1, further including:
documenting any performed care steps into the workflow data that deviate from the established clinical protocol and/or computer interpretable guidelines.

4. The method according to claim 1, wherein the step of selecting one of the previous care steps further includes:
selecting a series of preceding care steps such that an evolution of the care steps and the patient data is displayed.

5. The method according to claim 1, further including:
on a display unit displaying a care step map and the patient data as it existed at a time when the selected care step was performed.

6. The method according to claim 1, further including:
performing a comparative analysis to explore alternative hypothetical paths.

7. The method according to claim 6, wherein the comparative analysis provides one or more clinical recommendations based on one or more decision support models and further includes:
pursuing a hypothetical path; and
observing whether or not the one or more decision support models yield a more efficient recommendation.

8. (canceled)

9. (canceled)

10. A system for managing clinical protocols and/or clinical guidelines comprising:
a data collection engine that receives workflow data and patient data for a plurality of patients, wherein the workflow data includes a plurality of care steps for each of the patients and the patient data includes clinical data collected from each of the patient;
a data analysis engine that:
tracks the workflow and patient data for each of the patients; and
causes the workflow data and the patient data at the time of a selected previous care step for a select one of the patients to be displayed on a display.

11. The system according to claim 10, wherein the display displays a map of care steps called for by an established clinical protocol and/or computer interpretable guideline and the data analysis engine further inserts into the care step map on the display any added or different care steps that deviate from the established clinical protocol and/or computer interpretable guidelines.

12. The system according to claim 10, wherein the data analysis engine further:
generates and causes display of a visualization that illustrates a order of steps performed and/or care steps to be performed according to a clinical protocol and/or computer interpretable guidelines, wherein one of the care steps in the displayed visualization is selectable to cause the data analysis engine to retrieve and display the patient data as it existed at a time when the selected care step was performed.

13. The system according to claim 10, wherein the data analysis engine performs a comparative analysis to determine a probable outcome of a care step not performed in the patient case.

14. (canceled)

15. The system according to claim 10, wherein the comparative analysis provides one or more clinical recommendations based on one or more decision support models and further includes:
pursuing a hypothetical path; and
observing whether or not the one or more decision support models yield a more efficient recommendation.

16. A clinical workflow or decisions support manager comprising:
a data collection engine that collects workflow data and patient data for at least one patient, the workflow data including at least a current care step of a sequence of care steps prescribed by a clinical protocol and/or computer interpretable guideline describing the patient's treatment regimen and the patient data including clinical data collected from the patient over time;
a data analysis engine that tracks and records the patient data as of the time at which each of the care steps for the patient is performed;
a display that displays at least a selected one of the sequence of care steps and patient data as of the time the selected care step was performed on the patient.

17. (canceled)

18. (canceled)

19. The manager according to claim 16, wherein the data analysis engine further performs a comparative analysis to determine a probable outcome if a hypothetical care step were performed instead of the actual care step.

20. The manager according to claim 16, wherein comparative analysis is based on probability models of care steps performed on other patients with similar patient data to the patient data as of the time of the selected care step.
